(19) United States
(12) Patent Application Publication
(10) Pub. No.: US 2026/0067866 A1
(43) Pub. Date: Mar. 5, 2026

(54) SELF-SCHEDULING SUBPACKET ENCODING

(71) Applicant: QUALCOMM Incorporated, San Diego, CA (US)

(72) Inventors: Raviteja PATCHAVA, San Diego, CA (US); Jing SUN, San Diego, CA (US); Xiaoxia ZHANG, San Diego, CA (US); Junyi LI, Greentown, PA (US); Jing JIANG, San Diego, CA (US)

(21) Appl. No.: 18/817,054

(22) Filed: Aug. 27, 2024

(51) Int. Cl. H04W 72/02; H04L 1/00; H04L 1/1812

(52) U.S. Cl. CPC H04W 72/02; H04L 1/0042; H04L 1/1816

(57) ABSTRACT

Methods, systems, and devices for wireless communications are described. A user equipment (UE) may receive an indication of a self-scheduling resource pool associated with self-scheduling transmissions by the UE. The UE may encode, at a physical layer, data associated with a packet into a set of subpackets. Each subpacket of the set of subpackets may include a subset of the data and an identifier associated with the UE. The UE may transmit the set of subpackets via one or more resources of the self-scheduling resource pool.

### FIELD OF TECHNOLOGY

The following relates to wireless communications, including self-scheduling subpacket encoding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving an indication of a self-scheduling resource pool associated with self-scheduling transmissions by the UE, encoding, at a physical (PHY) layer, data associated with a packet into a set of multiple subpackets, where each subpacket of the set of multiple subpackets includes a subset of the data and an identifier (ID) associated with the UE, and transmitting the set of multiple subpackets via one or more resources of the self-scheduling resource pool.

A UE is described. The UE may include one or more memories storing processor executable code, and one or more processors coupled with the one or more memories. The one or more processors may individually or collectively be operable to execute the code to cause the UE to receive an indication of a self-scheduling resource pool associated with self-scheduling transmissions by the UE, encode, at a PHY layer, data associated with a packet into a set of multiple subpackets, where each subpacket of the set of multiple subpackets includes a subset of the data and an ID associated with the UE, and transmit the set of multiple subpackets via one or more resources of the self-scheduling resource pool.

Another UE is described. The UE may include means for receiving an indication of a self-scheduling resource pool associated with self-scheduling transmissions by the UE, means for encoding, at a PHY layer, data associated with a packet into a set of multiple subpackets, where each subpacket of the set of multiple subpackets includes a subset of the data and an ID associated with the UE, and means for transmitting the set of multiple subpackets via one or more resources of the self-scheduling resource pool.

A non-transitory computer-readable medium storing code is described. The code may include instructions executable by one or more processors to receive an indication of a self-scheduling resource pool associated with self-scheduling transmissions by the UE, encode, at a PHY layer, data associated with a packet into a set of multiple subpackets, where each subpacket of the set of multiple subpackets includes a subset of the data and an ID associated with the UE, and transmit the set of multiple subpackets via one or more resources of the self-scheduling resource pool.

In some examples of the method, UEs, and non-transitory computer-readable medium described herein, to transmitting the set of multiple subpackets may include operations, features, means, or instructions for transmitting a set of multiple cyclic redundancy check (CRC) corresponding to the set of multiple subpackets, where each subpacket includes a respective CRC.

Some examples of the method, UEs, and non-transitory computer-readable medium described herein may further include operations, features, means, or instructions for transmitting, via one or more subpackets of the set of multiple subpackets, one or more of: a subpacket ID indicating one or more other subpackets of the set of multiple subpackets, an order associated with the set of multiple subpackets, the ID associated with the UE, or any combination thereof.

In some examples of the method, UEs, and non-transitory computer-readable medium described herein, the indication of the one or more other subpackets includes a signature that indicates a transmission of the set of multiple subpackets.

Some examples of the method, UEs, and non-transitory computer-readable medium described herein may further include operations, features, means, or instructions for receiving a downlink control signal including a retransmission grant indicating a set of resources for retransmission of one or more subpackets of the set of multiple subpackets based on a reception status of the one or more subpackets of the set of multiple subpackets.

Some examples of the method, UEs, and non-transitory computer-readable medium described herein may further include operations, features, means, or instructions for retransmitting the one or more subpackets via the set of resources based on the retransmission grant.

Some examples of the method, UEs, and non-transitory computer-readable medium described herein may further include operations, features, means, or instructions for receiving a set of feedback bits corresponding to the set of multiple subpackets, where each feedback bit corresponds to a reception status of a respective subpacket of the set of multiple subpackets.

In some examples of the method, UEs, and non-transitory computer-readable medium described herein, to receiving the set of feedback bits may include operations, features, means, or instructions for receiving a downlink control signal including the set of feedback bits.

In some examples of the method, UEs, and non-transitory computer-readable medium described herein, to receiving the set of feedback bits may include operations, features, means, or instructions for receiving a medium access control (MAC) control element (MAC-CE) signal via a physical downlink shared channel (PDSCH) including the set of feedback bits.

Some examples of the method, UEs, and non-transitory computer-readable medium described herein may further include operations, features, means, or instructions for retransmitting one or more subpackets of the set of multiple subpackets via a next instance of the self-scheduling resource pool, where the one or more subpackets correspond to one or more negative acknowledgment (NACK) feedback bits of the set of feedback bits.

Some examples of the method, UEs, and non-transitory computer-readable medium described herein may further include operations, features, means, or instructions for receiving an indication of a decoding status associated with the set of multiple subpackets, where receiving the set of feedback bits may be based on the decoding status.

Some examples of the method, UEs, and non-transitory computer-readable medium described herein may further include operations, features, means, or instructions for receiving an indication of a transmit power control associated with a retransmissions of one or more subpackets of the set of multiple subpackets corresponding to one or more NACK feedback bits of the set of feedback bits.

Some examples of the method, UEs, and non-transitory computer-readable medium described herein may further include operations, features, means, or instructions for retransmitting the one or more subpackets in accordance with the transmit power control.

Some examples of the method, UEs, and non-transitory computer-readable medium described herein may further include operations, features, means, or instructions for receiving a set of feedback bits corresponding to a set of resources including at least the one or more resources, where each feedback bit corresponds to a reception of a subpacket via a respective resource.

Some examples of the method, UEs, and non-transitory computer-readable medium described herein may further include operations, features, means, or instructions for detecting a reception status of the set of multiple subpackets based on mapping the one or more resources associated with transmission of the set of multiple subpackets to the set of resources.

Some examples of the method, UEs, and non-transitory computer-readable medium described herein may further include operations, features, means, or instructions for retransmitting one or more subpackets of the set of multiple subpackets based on the set of feedback bits, where the one or more subpackets may be transmitted in accordance with a power ramp.

A method by a network entity is described. The method may include transmitting an indication of a self-scheduling resource pool associated with self-scheduling transmissions by one or more UEs, receiving one or more subpackets of a set of multiple subpackets via one or more resources of the self-scheduling resource pool, and decode, at a PHY layer, data associating with a packet based on the one or more subpackets, where each subpacket of the one or more subpackets includes a subset of the data and an ID associated with a UE of the one or more UEs.

A network entity is described. The network entity may include one or more memories storing processor executable code, and one or more processors coupled with the one or more memories. The one or more processors may individually or collectively be operable to execute the code to cause the network entity to transmit an indication of a self-scheduling resource pool associated with self-scheduling transmissions by one or more UEs, receive one or more subpackets of a set of multiple subpackets via one or more resources of the self-scheduling resource pool, and decode, at a PHY layer, data associate with a packet based on the one or more subpackets, where each subpacket of the one or more subpackets includes a subset of the data and an ID associated with a UE of the one or more UEs.

Another network entity is described. The network entity may include means for transmitting an indication of a self-scheduling resource pool associated with self-scheduling transmissions by one or more UEs, means for receiving one or more subpackets of a set of multiple subpackets via one or more resources of the self-scheduling resource pool, and means for decode, at a PHY layer, data associating with a packet based on the one or more subpackets, where each subpacket of the one or more subpackets includes a subset of the data and an ID associated with a UE of the one or more UEs.

A non-transitory computer-readable medium storing code is described. The code may include instructions executable by one or more processors to transmit an indication of a self-scheduling resource pool associated with self-scheduling transmissions by one or more UEs, receive one or more subpackets of a set of multiple subpackets via one or more resources of the self-scheduling resource pool, and decode, at a PHY layer, data associate with a packet based on the one or more subpackets, where each subpacket of the one or more subpackets includes a subset of the data and an ID associated with a UE of the one or more UEs.

In some examples of the method, network entities, and non-transitory computer-readable medium described herein, to receiving the set of multiple subpackets may include operations, features, means, or instructions for receiving a set of multiple CRC corresponding to the set of multiple subpackets, where each subpacket includes a respective CRC.

Some examples of the method, network entities, and non-transitory computer-readable medium described herein may further include operations, features, means, or instructions for receiving, via the one or more subpackets of the set of multiple subpackets, a subpacket ID indicating one or more other subpackets of the set of multiple subpackets, an order associated with the set of multiple subpackets, the ID associated with the UE, or any combination thereof.

In some examples of the method, network entities, and non-transitory computer-readable medium described herein, the indication of the one or more other subpackets includes a signature that indicates a transmission of the set of multiple subpackets.

Some examples of the method, network entities, and non-transitory computer-readable medium described herein may further include operations, features, means, or instructions for transmitting a set of feedback bits corresponding to the set of multiple subpackets, where each feedback bit corresponds to a reception status of a respective subpacket of the set of multiple subpackets.

In some examples of the method, network entities, and non-transitory computer-readable medium described herein, decode at least one of the one or more subpackets, where transmitting the set of feedback bits may be based on the decoding.

In some examples of the method, network entities, and non-transitory computer-readable medium described herein, to transmitting the set of feedback bits may include operations, features, means, or instructions for transmitting a downlink control signal including the set of feedback bits.

In some examples of the method, network entities, and non-transitory computer-readable medium described herein, to transmitting the set of feedback bits may include operations, features, means, or instructions for transmitting a MAC-CE signal via a PDSCH including the set of feedback bits.

Some examples of the method, network entities, and non-transitory computer-readable medium described herein may further include operations, features, means, or instructions for receiving retransmissions of one or more additional subpackets of the set of multiple subpackets via a next instance of the self-scheduling resource pool, where the one or more additional subpackets correspond to one or more NACK feedback bits of the set of feedback bits.

Some examples of the method, network entities, and non-transitory computer-readable medium described herein may further include operations, features, means, or instructions for transmitting an indication of a decoding status associated with the set of multiple subpackets, where transmitting the set of feedback bits may be based on the decoding status.

Some examples of the method, network entities, and non-transitory computer-readable medium described herein may further include operations, features, means, or instructions for transmitting a downlink control signal including a retransmission grant indicating a set of resources for retransmission of one or more additional subpackets of the set of multiple subpackets based on a reception status of the one or more additional subpackets of the set of multiple subpackets.

Some examples of the method, network entities, and non-transitory computer-readable medium described herein may further include operations, features, means, or instructions for transmitting a set of feedback bits corresponding to a set of resources including at least the one or more resources, where each feedback bit corresponds to a reception of a subpacket via a respective resource.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports self-scheduling subpacket encoding in accordance with one or more aspects of the present disclosure.

FIG. 2 shows an example of a wireless communications system that supports self-scheduling subpacket encoding in accordance with one or more aspects of the present disclosure.

FIG. 3A shows an example of a feedback configuration that supports self-scheduling subpacket encoding in accordance with one or more aspects of the present disclosure.

FIG. 3B shows an example of a feedback configuration that supports self-scheduling subpacket encoding in accordance with one or more aspects of the present disclosure.

FIG. 4 shows an example of a process flow that supports self-scheduling subpacket encoding in accordance with one or more aspects of the present disclosure.

FIGS. 5 and 6 show block diagrams of devices that support self-scheduling subpacket encoding in accordance with one or more aspects of the present disclosure.

FIG. 7 shows a block diagram of a communications manager that supports self-scheduling subpacket encoding in accordance with one or more aspects of the present disclosure.

FIG. 8 shows a diagram of a system including a device that supports self-scheduling subpacket encoding in accordance with one or more aspects of the present disclosure.

FIGS. 9 and 10 show block diagrams of devices that support self-scheduling subpacket encoding in accordance with one or more aspects of the present disclosure.

FIG. 11 shows a block diagram of a communications manager that supports self-scheduling subpacket encoding in accordance with one or more aspects of the present disclosure.

FIG. 12 shows a diagram of a system including a device that supports self-scheduling subpacket encoding in accordance with one or more aspects of the present disclosure.

FIGS. 13 through 17 show flowcharts illustrating methods that support self-scheduling subpacket encoding in accordance with one or more aspects of the present disclosure.

### DETAILED DESCRIPTION

In some wireless communications systems, a network entity may configure a user equipment (UE) with a self-scheduling resource pool. The UE may transmit uplink data to a network entity via uplink resources of the self-scheduling resource pool. The UE may select the uplink resources in the self-scheduling resource pool, and the UE may transmit the uplink data via the resources without scheduling signaling from the network entity. The network entity may perform blind channel estimation and blind decoding in the self-scheduling resource pool to receive the uplink data. The blind channel estimation and blind decoding may be associated with a relatively high power consumption and overhead at the network entity.

According to techniques described herein, a self-scheduling resource pool may include a resource structure associated with decreased blind decoding and power consumption at the network entity during receive operations. A UE may encode a packet (e.g., a physical layer transport block (TB), a media access control (MAC) layer packet, or a higher-layer packet) into multiple subpackets. Each subpacket may include a UE identifier (ID) and a cyclic redundancy check (CRC) for independent decoding of the subpacket. Additionally, or alternatively, the subpackets may include an indication of the multiple subpackets (e.g., a quantity of subpackets associated with the packet). The self-scheduling resource pool may be divided into multiple communication resources, and each communication resource may be the size of a subpacket. Each subpacket may be transmitted over a respective communication resource in the self-scheduling resource pool. The network entity may receive one or more of the subpackets and transmit feedback indicating the reception status of the subpackets. The resource structure associated with the self-scheduling resource pool may decrease the power consumption of blind channel estimation and blind decoding performed by the network entity. For example, the resource structure may decrease downlink control signaling from the network entity. Additionally, or alternatively, the resources structure may enable the UE to perform retransmissions per-subpacket decrease a total quantity of data retransmitted.

Aspects of the disclosure are initially described in the context of wireless communications systems. Additional aspects of the disclosure are described in the context of a feedback configuration and process flow. Aspects of the disclosure are further illustrated by and described with reference to apparatus diagrams, system diagrams, and flowcharts that relate to self-scheduling subpacket encoding.

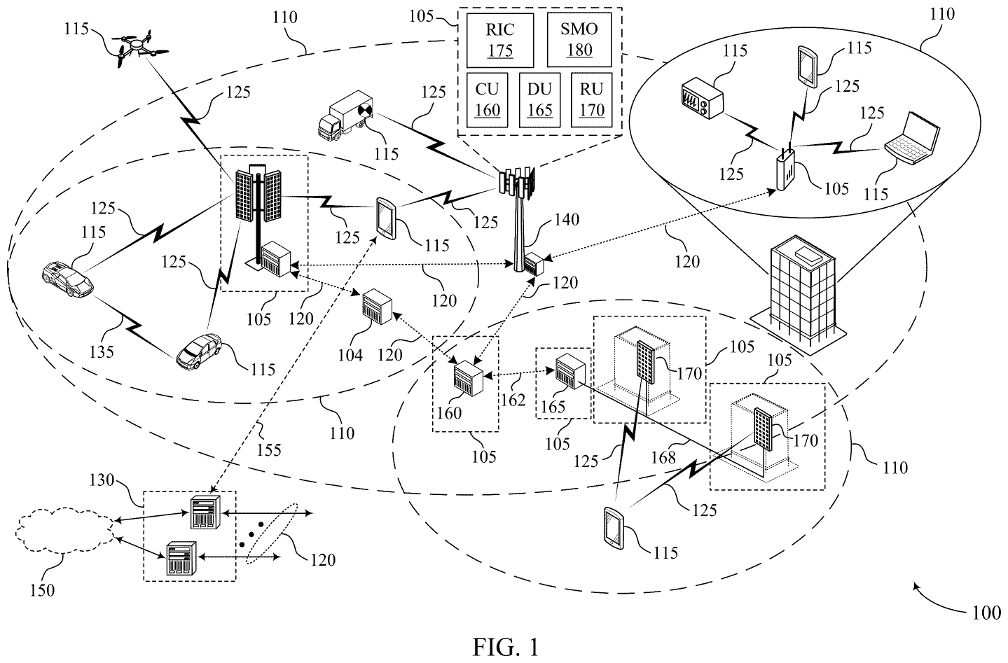

FIG. 1 shows an example of a wireless communications system 100 that supports self-scheduling subpacket encoding in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a CRC), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a self-scheduling resource pool may include a resource structure decreasing the processing at a network entity 105. A UE 115 may encode a packet (e.g., a physical layer TB, a MAC layer packet, or a higher-layer packet, such as an internet protocol (IP) packet included as the payload of a lower-layer packet) into multiple subpackets. Each subpacket may include (e.g., may include bits indicating) a UE ID and a CRC for independent decoding of the subpacket. The self-scheduling resource pool may be divided into multiple communication resources. Each communication resource may be the size of a subpacket. Additionally, or alternatively, the subpackets may include an indication of the multiple subpackets (e.g., a quantity of subpackets associated with the packet). Each subpacket may be transmitted over a respective communication resource in the self-scheduling resource pool. The network entity 105 may receive one or more of the subpackets and transmit feedback indicating the reception status of the subpackets. The resource structure associated with the self-scheduling resource pool may decrease the power consumption of blind channel estimation and blind decoding performed by the network entity 105.

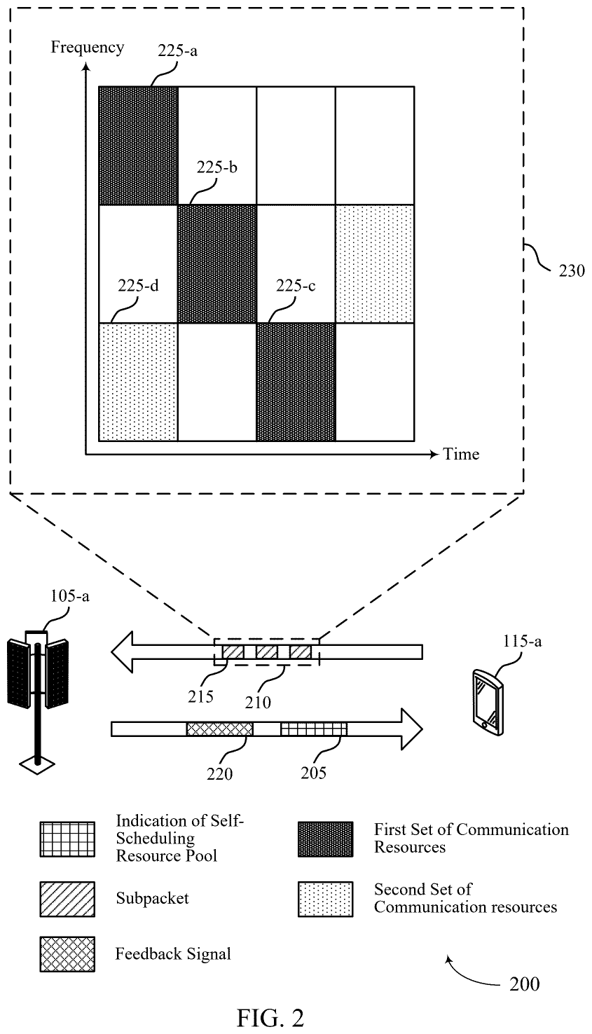

FIG. 2 shows an example of a wireless communications system 200 that supports self-scheduling subpacket encoding in accordance with one or more aspects of the present disclosure. In some examples, wireless communications system 200 may implement aspects of wireless communications system 100. For example, a UE 115-a may represent an example of a UE, such as the UEs 115 described with reference to FIG. 1. A network entity 105 a and a network entity 105-b may represent an example of a network entity, such as the network entities 105 described with reference to FIG. 1. The UE 115-a may communicate with the network entity 105 a via self-scheduled uplink transmissions.

In some wireless communications systems, a network entity 105-a may schedule uplink communication resources on a per-UE basis. The network entity 105-a may transmit a relatively large quantity of control signals, particularly, in the case of a high quantity of UEs 115 (e.g., IoT devices). The relatively large quantity of control signals may increase power consumption at the network entity 105-a and increase a signaling overhead of uplink communication.

Self-scheduled uplink transmissions may reduce the signaling overhead of uplink communications (e.g., the signaling overhead at the network entity 105-a). The network entity 105-a may use one or more configured grants (CGs) to indicate a self-scheduling resource pool 230 to each participating UE 115-a for the self-scheduled uplink transmissions. For example, the network entity 105 may transmit an indication of a self-scheduling resource pool 205 to the UE 115-a. The UE 115-a may self-schedule uplink transmissions in accordance with the configurations or within the self-scheduling resource pool 230. The self-scheduled uplink transmissions may reduce the downlink control overhead (e.g., power saving and resource saving for the network entity 105-a).

In some cases, a UE 115-a may perform self-scheduled uplink transmissions via multiple overlapping CG physical uplink shared channel (PUSCH) communication resources 225 configured by the network entity 105-a. The UE 115-a may select one of the communication resources 225 on which to transmit.

For self-scheduled uplink transmissions, the UE 115-a may directly select a communication resource 225 for a given payload size and transmit uplink data over the PUSCH via the communication resource 225. In some cases, different UEs 115 may independently and separately transmit on colliding communication resources 225, which may result in interference. The interference between the different UEs 115 may degrade performance. For example, the UE 115-a may select a first communication resource 225 and transmit a first uplink transmission via the first communication resource 225. An additional UE 115 may also select the first communication resource 225 and transmit a second uplink transmission via the first communication resource 225. The UE 115-a and the additional UE 115 may randomly select the first communication resource 225 or in accordance with a configuration (e.g., a configuration indicated by the network entity 105-a). The first uplink transmission and the second uplink transmission, both transmitted via the first communication resource 225, may create interference and degrade performance. The network entity 105-a may not receive the first uplink transmission or the second uplink transmission due to the interferences created by the uplink transmissions. The network entity 105-a may be unable to determine which uplink transmission was not received.

A CRC may uniquely identify the first uplink transmission and the second uplink transmission. In some cases, the self-scheduling resource pool 230 may implement one or more aspects of a physical downlink control channel (PDCCH) search space design.

In some examples, the network entity 105-a may allocate each communication resource 225 in the self-scheduling resource pool 230 to multiple UEs 115. The allocation may be similar to the PUSCH part of a two-step random access channel (RACH). The network entity 105-a may not transmit a physical random access channel (PRACH) prior to receiving a self-scheduled uplink transmission (e.g., PUSCH transmission). Additionally, or alternatively, multiple configurations (e.g., possibly overlapping configurations) may support payload and modulation and coding schemes (MCS) adaptation.

The network entity 105-a may configure one or more parameters associated with the self-scheduling resource pool 230. In some examples, the self-scheduling resource pool 230 may be structured for CG-PUSCH. The network entity 105-a may control or signal to the UE 115-a a probabilistic criterion by which the UE 115-a may access the self-scheduling resource pool 230 using one of the communication resources 225 in the self-scheduling resource pool 230. In some examples, the network entity 105-a may indicate a probabilistic backoff or other access parameter to the UE 115-a for use in accessing a communication resource 225 in the self-scheduling resource pool 230. In some examples, the network entity 105-a may adjust a size of the self-scheduling resource pool 230 (e.g., instead of adjusting a UE access probability). In some examples, the network entity 105-a may configure heterogeneous self-scheduling resource pools 230, and the network entity 105-a may support an extra dimension of flexibility in selecting the communication resources 225.

The transmitter (e.g., UE 115-a) behavior may be relatively simple. For example, the UE 115-a may select a communication resource 225 to transmit based on an MCS and a payload size associated with the communication resource 225 (e.g., a proper MCS and payload size). The receiver (e.g., network entity 105-a) behavior may involve heavy usage of processing resources. For example, the network entity 105-a may perform blind channel estimation and blind decoding for each of the communication resources 225 in the self-scheduling resource pool 230. Performing blind channel estimations and blind decodes for each communication resource 225 may be associated with a high overhead. For example, the network entity 105-a may be able to perform blind channel estimations and blind decodes for a threshold quantity of communication resources (e.g., self-scheduled uplink transmissions may work for small scale implementations).

The network entity 105-a may transmit acknowledgment (ACK) or negative acknowledgment (NACK) feedback for the self-scheduling resource pool 230. For example, the network entity 105-a may transmit feedback signal 220 indicating if the network entity 105-a was able to successfully receive and decode an uplink transmission from the UE 115-a via the self-scheduling resource pool 230. The UE 115-a may retransmit an uplink transmission via the self-scheduling resource pool 230 or a subsequent instance of the self-scheduling resource pool 230 based on the feedback signal 220.

According to techniques described herein, processing (e.g., processing associated with performing blind channel estimations and blind decodes) at the network entity 105-a may be simplified by configuring a structure in the self-scheduling resource pool 230. For example, the UE 115-a may split a packet 210 (e.g., a transport block or MAC or higher-layer payload) into multiple subpackets 215. Each subpacket 215 may be confined to one unit of communication resources (e.g., one communication resource 225).

The network entity 105-a may indicate a self-scheduling resource pool 230 for self-scheduling uplink transmission to one or more UEs 115. The UE 115-a may encode the packet 210 into multiple subpackets 215. The UE 115-a may transmit the subpackets 215 via a first set of communication resources of the self-scheduling resource pool 230. For example, the UE 115-a may transmit a first subpacket 215 via a first communication resource 225-a (e.g., at a first time and at a first frequency), a second subpacket 215 via a second communication resource 225-b, and a third subpacket 215 via a third communication resource 225-c. An additional UE 115 may transmit multiple subpackets via a second set of communication resources. In some examples, the additional UE 115 may transmit a fourth subpacket via a fourth communication resource 225-d (e.g., at the first time and a second frequency). In some examples, the additional UE 115 may transmit a fourth subpack via the first communication resource 225-a. In other words, the first set of communication resources and the second set of communication resources may be overlapping.

Each subpacket 215 may be independently encoded and carry signaling overhead to identify the UE 115-a, and in some cases, the packet 210. Each subpacket 215 may include UE ID information (e.g., cell radio network temporary ID (C-RNTI)). Each subpacket 215 may include a CRC calculated based on the subpacket 215 for independent decoding. The UE 115-a may support multiple parallel PUSCH transmissions at the same time (e.g., multiple PUSCH transmissions associated with each subpacket 215).

The subpackets 215 may include one or more IDs that enable the network entity 105-a to identify the one or more other subpackets 215 transmitted by the UE 115-a and including other portions of the packet 210. For example, a subpacket 215 may include signaling overhead (e.g., a signature) including packet information indicating if other subpackets 215 are transmitted. The packet information may provide a hole detection mechanism to provide robustness and increase communications reliability. The packet information may enable the network entity 105-a to determine whether to expect other subpacket 215 transmissions associated with the same packet 210. The packet information may include the order of the subpacket 215 in the current packet 210 (e.g., similar to a downlink assignment index (DAI)) and the total quantity of transmitted subpackets 215 in the current transmission (e.g., the total quantity of subpackets 215 transmitted by the UE 115 including portions of the packet 210). The network entity 105-a may use the packet information for stitching subpackets 215 in a correct order to form the packet 210.

For example, the network entity 105-a may receive the first subpacket 215 transmitted via the first communication resource 225-a. The first subpacket 215 may indicate that the packet 210 has been encoded into a first quantity subpackets (e.g., three subpackets). Additionally, or alternatively, the first subpacket 215 may indicate an ID associated with the order of the multiple subpackets (e.g., total quantity of subpackets 215 transmitted by the UE 115 including portions of the packet 210). For example, an ID included in the first subpacket 215 may indicate that the first subpacket 215 is an initial subpacket in the order of the multiple subpackets. The network entity 105-a may receive the third subpacket 215 transmitted via the third communication resources 225-c. An ID included in the third subpacket 215 may indicate that the third subpacket is a third subpacket in the order of the multiple subpackets.

The network entity 105-a may determine that the UE 115-a transmitted the second subpacket 215, and the network entity 105-a did not successfully receive or successfully decode the second subpacket 215. The network entity 105-a may transmit a feedback signal 220 including an indication of the received subpackets (e.g., the first subpacket 215 and the third subpacket 215) and the unreceived subpacket (e.g., the second subpacket 215).

Additionally, or alternatively, the subpacket 215 may include a list of communication resources 225 used to transmit the other subpacket 215 from the same UE 115-a. The network entity 105-a may use the list of communication resources 225 to decode the other transmissions (e.g., the other subpackets 215) from the UE 115-a.

For example, the first subpacket 215 may include a list of communication resources 225 indicating one or more communication resources used to transmit the other subpackets 215. For example, the first subpacket 215 may include an indication of the second communication resource 225-b and the third communication resource 225-c. The network entity 105-a may use the list of the communication resources 225 to successfully receive and decode the second subpacket 215 and the third subpacket 215.

The network entity 105-a may decode each subpacket 215 based on an independent CRC. The independent CRC may be calculated based on the subpacket 215 and be included in the subpacket 215. The network entity 105-a may utilize the independent CRC to verify the content of the subpacket 215. The size of the subpacket 215 may be same across all the communication resources 225 which may help the network entity 105-a to use a common set of decoding resources to decode each subpacket.

Based on the packet information (e.g., the UE ID and the subpacket ID) in the subpacket 215, the network entity 105-a may stitch the multiple subpackets 215 to form the packet 210. The splitting and merging of the subpackets may occur at a PHY layer level rather than the MAC layer which may utilize a MAC overhead for each transmission.

The network entity 105-a may provide feedback for each subpacket 215. For example, the network entity 105-a may transmit a reception status (e.g., ACK or NACK feedback) for subpacket level retransmission. The ACK or NACK mechanism per subpacket 215 may support retransmissions of unreceive subpackets 215. The subpackets 215 may implement aspects of a code block group (CBG) or code block group retransmissions.

In some cases, the network entity 105-a may transmit downlink control information (DCI). The DCI may include the feedback signal 220. When the network entity 105-a decodes some or all of subpackets 215 from the UE 115-a, the network entity 105-a may transmit a DCI including the feedback signal 220 if at least one of the subpackets 215 from the UE 115-a was successfully decoded. A CRC of the DCI may be scrambled with the UE ID. The UE ID may be recovered from the payload of the decoded subpackets 215. If there are sparse transmissions from the UE 115-a, the quantity of DCI may be low. For example, a relatively few quantity of DCI may be sufficient.

In some examples, the DCI may serve as a retransmission grant granting the resources for retransmission of the subpackets 215 corresponding to NACK feedback.

For example, the network entity 105-a may allocate an explicit uplink resource grant for the retransmission of the un-decoded subpackets 215. The coded bits of subpackets 215 may be rate matched into the allocated resources.

In some examples, the DCI may include the ACK or NACK feedback, and the UE 115-a may retransmit the subpackets corresponding to NACK feedback in the next instance of the self-scheduling resource pool 230. The retransmission may implement aspects of a data flow interface.

The network entity 105-a may indicate a transmit power control for the next transmissions from the UE 115-a. The transmit power control may indicate a transmit power for a next retransmission or new transmission from the UE 115-a.

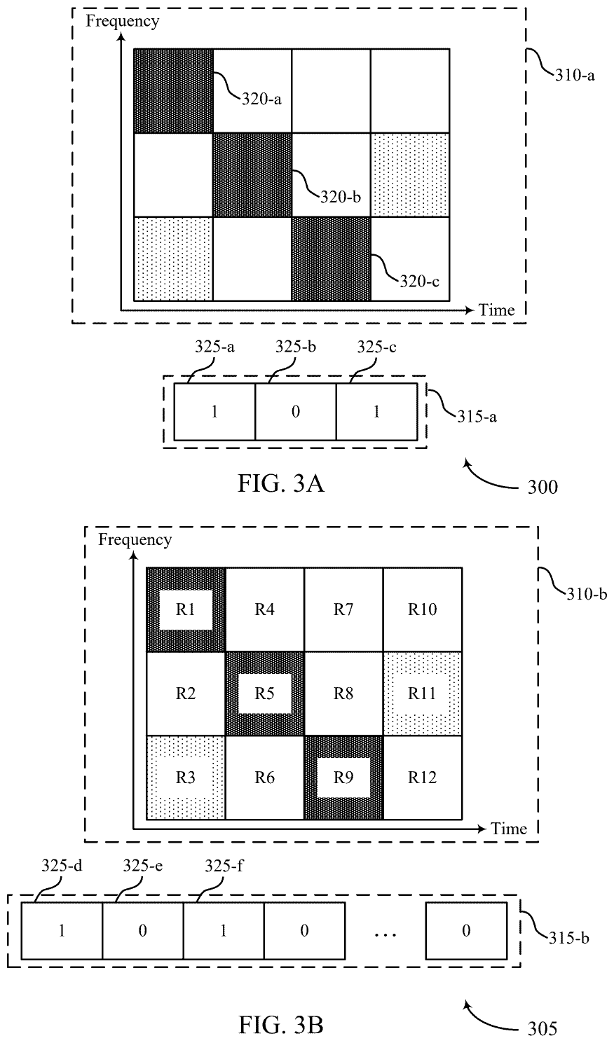

FIG. 3A shows an example of a feedback configuration 300 that supports self-scheduling subpacket encoding in accordance with one or more aspects of the present disclosure. In some examples, the feedback configuration 300 may implement aspects of wireless communications system 100 and wireless communications system 200. For example, a network entity 105 may transmit a feedback signal (e.g., the feedback signal 220 as described with reference to FIG. 2) to a UE 115 in accordance with the feedback configuration 300. The network entity 105 and the UE 115 may be examples of corresponding devices described with reference to FIGS. 1 and 2.

The network entity 105-a may allocate a bit 325 in feedback (e.g., DCI carrying HARQ feedback for the uplink packet) for each subpacket. Each bit may indicate the ACK or NACK for each subpacket transmitted by the UE 115. As described herein, if network entity 105 decodes at least one subpacket, then the network entity 105 may determine information of all other subpackets transmitted by the UE 115. For example, the network entity 105 may determine a quantity of subpackets transmitted by the UE 115 or communication resources 320 used to transmit the subpackets. The quantity of bits allocated for the ACK or NACK may be the same as a threshold quantity (e.g., maximum quantity) of subpackets that can be transmitted by the UE 115.

Additionally, or alternatively, the network entity 105 may indicate whether all the subpackets in the packet have been successfully decoded. If some of the subpackets in the packet are not decoded, then network entity 105 may allocate additional bits 325 indicating the subpacket level ACK or NACK.

For example, a UE 115 may transmit multiple subpackets via a first set of communication resources of the self-scheduling resource pool 310-a. The network entity 105 may receive a first subpacket via a communication resource 320-a, fail to receive or decode a second subpacket via a communication resource 320-b, and receive a third subpacket via communication resource 320-c. As described with reference to FIG. 2, the network entity 105-a may determine a total quantity of subpackets transmitted by the UE 115 (e.g., three), and the network entity 105 may identify that the UE 115 transmitted the unreceived second subpacket.

The network entity 105 may transmit a feedback signal 315-a. The feedback signal 315-a may include an initial bit 325 (not shown) that indicates that all the subpackets transmitted by the UE 115 were not successfully received and decoded. Additionally, or alternatively, the network entity 105 may include a bit 325 for each subpacket transmitted by the first UE 115 in the feedback signal 315-a. For example, the network entity 105 may set a first bit 325-a of the feedback signal 315-a to 1 to indicate an ACK of the first subpacket. The network entity 105 may set a second bit 325-b of the feedback signal 315-a to 0 to indicate a NACK of the second subpacket. The network entity 105 may set a third bit 325-c of the feedback signal 315-a to 1 to indicate an ACK of the third subpacket.

If UE 115 detects the entire packet got successfully decoded, the UE 115 may proceed with a new transmission. In some examples, the new transmission may be in accordance with a received power control. If the UE 115 detects the entire packet is lost (e.g., the UE 115 receive no feedback from the network entity 105), then the UE 115 may proceed with a retransmission of the subpackets. In some examples, the retransmission may be in accordance with a configured power boost. After a threshold quantity of unsuccessful attempts, the UE 115-a may initiate a PRACH procedure. If the UE 115 detects a few subpackets were successfully decoded (e.g., the UE receives feedback signaling including both ACK and NACK), then the UE 115 may proceed with the retransmission of the subpackets corresponding to the NACK feedback (e.g., the remaining subpackets). In some examples, the retransmission of the remaining subpackets may be in accordance with a received power control. In some examples, the retransmission for the remaining packets may be in accordance with an explicit uplink grant, and the UE 115 may retransmit the subpackets in the assigned uplink resources.

The network entity 105 may embed the feedback information of ACK or NACK regarding multiple UEs 115 in a physical downlink shared channel (PDSCH). The network entity may indicate the feedback to the UEs 115 using DCI scrambled with an ID related to the group of resources. The DCI scrambling may implement aspects of a RACH message 2 scrambling procedure. The PDSCH may carry information to control the retransmission of one or more UEs 115 (e.g., the one or more detected UEs). For each UE 115, the contents of PDSCH may allocate a bit in feedback for each subpacket.

FIG. 3B shows an example of a feedback configuration 305 that supports self-scheduling subpacket encoding in accordance with one or more aspects of the present disclosure. In some examples, the feedback configuration 305 may implement aspects of wireless communications system 100, wireless communications system 200, or the feedback configuration 300. For example, a network entity 105 may transmit a feedback signal (e.g., the feedback signal 220 as described with reference to FIG. 2) to a UE 115 in accordance with the feedback configuration 305. The network entity 105 and the UE 115 may be examples of corresponding devices described with reference to FIGS. 1 and 3A.

The network entity 105 may allocate a bit 325 for each communication resource 320 in the self-scheduling resource pool 310-b. Each bit 325 may indicate the ACK or NACK for the corresponding communication resource 320 in a feedback signal 315 (e.g., GC-PDCCH). As described herein, a subpacket may be confined within one communication resource 320. The quantity of bits transmitted by the network entity 105 in the feedback configuration 305 may be less than the quantity of bits 325 transmitted by the network entity in feedback configuration 300.

The UE 115 may detect the ACK or NACK feedback for each subpacket by mapping the transmitted resources with the bits 325 in the feedback signal 315-b (e.g., GC-PDCCH). If UE detects a NACK for a resource used to transmit a subpacket, the UE 115 may retransmit the subpacket in accordance with a configured power ramp.

For example, a first UE 115 may transmit multiple subpackets via a first set of communication resources. Additionally, or alternatively, a second UE 115 may transmit multiple subpackets via a second set of communication resources. The network entity 105 may receive a first subpacket from the first UE 115 via a first communication resource 320 (R1), fail to receive or decode a subpacket via a second communication resource 320 (R2), and receive a second subpacket from the second UE 115 via a third communication resource 320 (R3).

The network entity may transmit a feedback signal 315-b. The feedback signal 315-b may include a bit 325 indicating a reception status (e.g., ACK or NACK) of a subpacket for each communication resource 320 in the self-scheduling resource pool 310-b. For example, the network entity 105 may set a first bit 325-d of the feedback signal 315-b to 1 to indicate an ACK of a reception of a subpacket via the first communication resource 320 (R1). The network entity 105 may set a second bit 325-e of the feedback signal 315-b to 0 to indicate a NACK of a reception of a subpacket via the second communication resource 320 (R2). The network entity 105 may set a third bit 325-f of the feedback signal 315-b to 1 to indicate an ACK of a reception of a subpacket via the third communication resource 320 (R3). The network entity 105 may set a bit for each communication resource 320 in the self-scheduling resource pool 310-b based on the reception of a subpacket via the corresponding communication resource 320. For example, for the feedback signal 315-b may include the bits “101010001010” to indicate the reception of a subpacket via communication resources 320 (R1, R3, R5, R9, and R11).

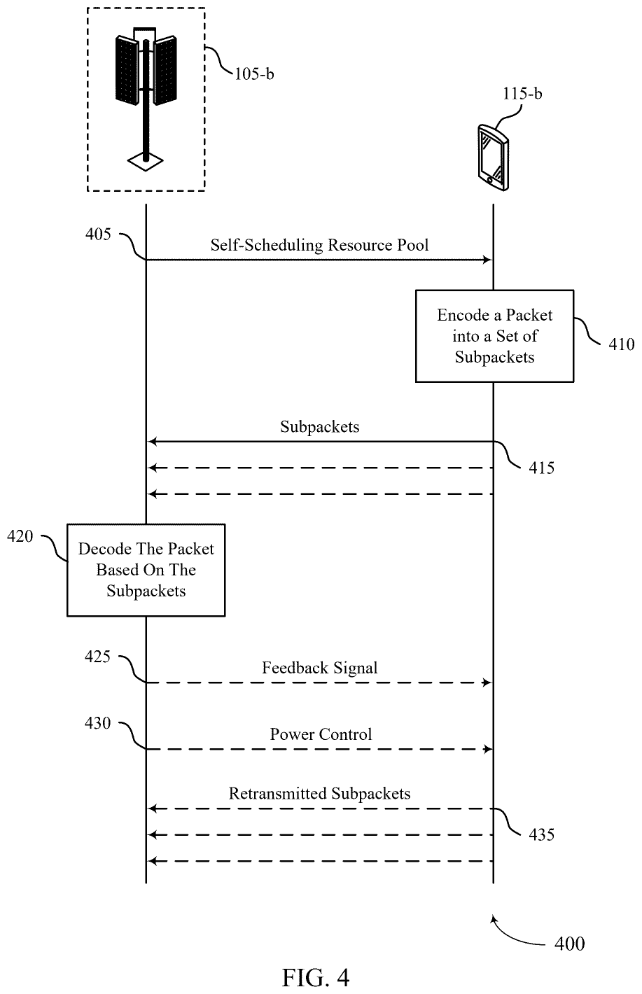

FIG. 4 shows an example of a process flow 400 that supports self-scheduling subpacket encoding in accordance with one or more aspects of the present disclosure. In some examples, process flow 400 may implement aspects of, or be implemented by aspects of, the wireless communications system 100, the wireless communications system 200, the feedback configuration 300, or the feedback configuration 305. For example, the process flow 400 may include a UE 115-b and a network entity 105-b which may be examples of corresponding devices described with reference to FIG. 1-3B.

At 405, the UE 115-b may receive an indication of a self-scheduling resource pool associated with self-scheduling transmissions by the UE 115-b. At 410, the UE 115-b may encode, at a PHY layer, data associated with a packet (e.g., TB) into a set of subpackets. Each subpacket of the set of subpackets may include a subset of the data and an ID associated with the UE.

At 415, the UE 115-b may transmit the set of subpackets via one or more resources of the self-scheduling resource pool, and the network entity 105-b may receive one or more subpackets of the set of subpackets. In some cases, the UE 115-b may transmit a set of CRC corresponding to the plurality of subpackets. Each subpacket may include a respective CRC. In some cases, the UE 115-b may transmit, via one or more subpackets of the set of subpackets, a subpacket ID indicating one or more other subpackets of the set of subpackets, an order associated with the set of subpackets, a UE ID, or any combination thereof. The indication of the one or more other subpackets may include a signature that indicates a transmission of the set of subpackets.

At 420, the network entity 105-b may decode, at a PHY layer, data associated with a packet based on one or more received subpackets. Each subpacket of the one or more received subpackets may include a subset of the data and an ID associated with a UE of the one or more UEs (e.g., the UE 115-b).

In some cases, at 425, the network entity 105-b may transmit a feedback signal (e.g., the feedback signal 220 as described with reference to FIG. 2). The network entity 105-b may transmit the feedback signal in accordance with feedback configuration 300 as described with reference to FIG. 3A or feedback configuration 305 as described with reference to FIG. 3B.

In some cases, the feedback signal may include a retransmission grant. For example, the UE 115-b may receive a DCI signal including a retransmission grant indicating a set of resources for retransmission of one or more subpackets of the set of subpackets based on a reception status (e.g., ACK or NACK feedback) of the one or more subpackets of the set of subpackets.

In some cases, the feedback signal may include a set of feedback bits corresponding to the set of subpackets as described with reference to FIG. 3A. For example, the UE 115-b may receive a set of feedback bits corresponding to the set of subpackets. Each feedback bit may correspond to a reception status of a respective subpacket of the set of subpackets. In some examples, the UE 115-b may receive a DCI signal including the set of feedback bits. In some examples, the UE 115-b may receive a MAC control element (MAC-CE) signal via a PDSCH including the set of feedback bits.

In some cases, the feedback signal may include a decoding status. For example, the UE 115-b may receive an indication of a decoding status associated with the set of subpackets. Receiving the set of feedback bits may be based on the decoding status. In some cases, the network entity 105-b may transmit the set of feedback bits based on the network entity 105-b decoding at least one of the one or more received subpackets.

In some cases, the feedback signal may include a set of feedback bits corresponding to the set of resources as described with reference to FIG. 3B. For example, the UE 115-b may receive a set of feedback bits corresponding to a set of resources including at least the one or more resources. Each feedback bit may correspond to a reception of a subpacket via a respective resource. The UE 115-b may detect a reception status of the set of subpackets based on mapping the one or more resources associated with transmission of the set of subpackets to the set of resources.

In some cases, at 430, the UE 115-b may receive an indication of a transmit power control associated with a retransmissions of one or more subpackets of the set of subpackets corresponding to one or more NACK feedback bits of the set of feedback bits.

In some cases, at 435, the UE 115-b may retransmit the one or more subpackets via the set of resources based on the retransmission grant. In some cases, the UE 115-b may retransmit one or more subpackets of the set of subpackets via a next instance of the self-scheduling resource pool. The one or more subpackets may correspond to one or more NACK feedback bits of the set of feedback bits. In some cases, the UE 115-b may retransmit the one or more subpackets in accordance with the transmit power control. In some cases, the UE 115-b may retransmit one or more subpackets of the set of subpackets based on the set of feedback bits. The one or more subpackets may be transmitted in accordance with a power ramp.

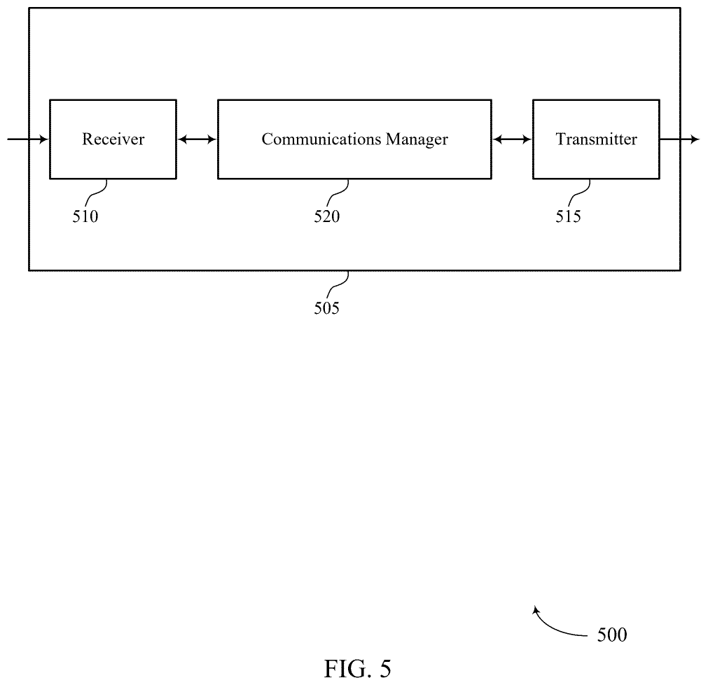

FIG. 5 shows a block diagram 500 of a device 505 that supports self-scheduling subpacket encoding in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to self-scheduling subpacket encoding). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to self-scheduling subpacket encoding). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of self-scheduling subpacket encoding as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving an indication of a self-scheduling resource pool associated with self-scheduling transmissions by the UE. The communications manager 520 is capable of, configured to, or operable to support a means for encoding, at a PHY layer, data associated with a packet into a set of multiple subpackets, where each subpacket of the set of multiple subpackets includes a subset of the data and an ID associated with the UE. The communications manager 520 is capable of, configured to, or operable to support a means for transmitting the set of multiple subpackets via one or more resources of the self-scheduling resource pool.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, more efficient utilization of communication resources, and the like.

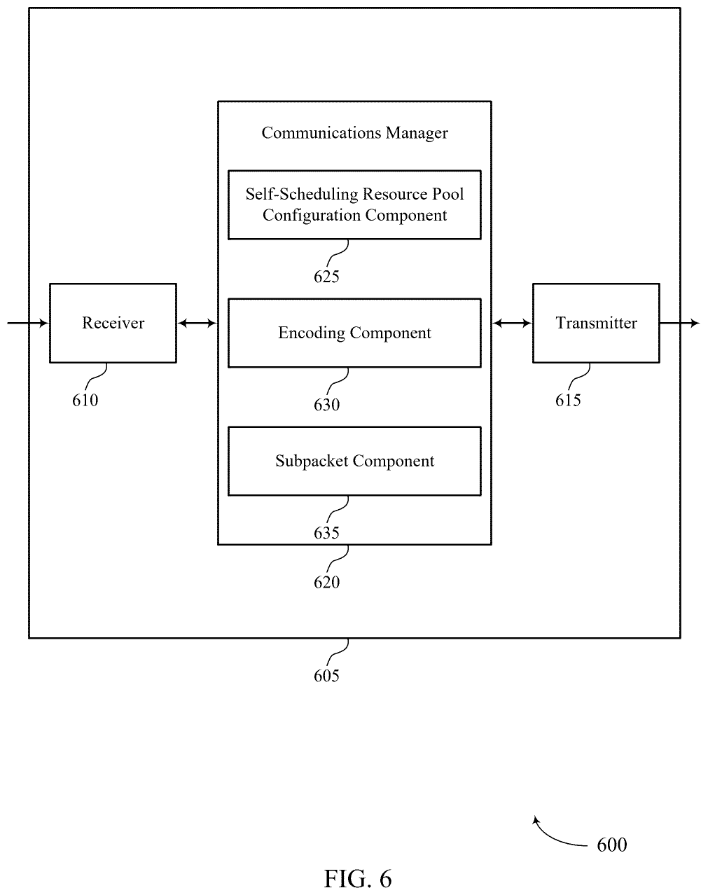

FIG. 6 shows a block diagram 600 of a device 605 that supports self-scheduling subpacket encoding in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to self-scheduling subpacket encoding). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to self-scheduling subpacket encoding). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of self-scheduling subpacket encoding as described herein. For example, the communications manager 620 may include a self-scheduling resource pool configuration component 625, an encoding component 630, a subpacket component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The self-scheduling resource pool configuration component 625 is capable of, configured to, or operable to support a means for receiving an indication of a self-scheduling resource pool associated with self-scheduling transmissions by the UE. The encoding component 630 is capable of, configured to, or operable to support a means for encoding, at a PHY layer, data associated with a packet into a set of multiple subpackets, where each subpacket of the set of multiple subpackets includes a subset of the data and an ID associated with the UE. The subpacket component 635 is capable of, configured to, or operable to support a means for transmitting the set of multiple subpackets via one or more resources of the self-scheduling resource pool.

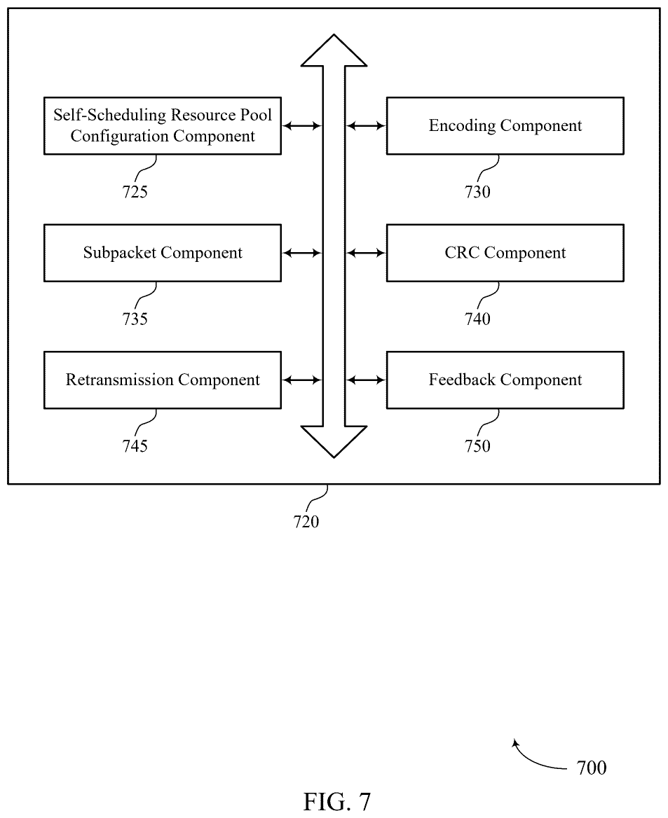

FIG. 7 shows a block diagram 700 of a communications manager 720 that supports self-scheduling subpacket encoding in accordance with one or more aspects of the present disclosure. The communications manager 720 may be an example of aspects of a communications manager 520, a communications manager 620, or both, as described herein. The communications manager 720, or various components thereof, may be an example of means for performing various aspects of self-scheduling subpacket encoding as described herein. For example, the communications manager 720 may include a self-scheduling resource pool configuration component 725, an encoding component 730, a subpacket component 735, an CRC component 740, a retransmission component 745, a feedback component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The self-scheduling resource pool configuration component 725 is capable of, configured to, or operable to support a means for receiving an indication of a self-scheduling resource pool associated with self-scheduling transmissions by the UE. The encoding component 730 is capable of, configured to, or operable to support a means for encoding, at a PHY layer, data associated with a packet into a set of multiple subpackets, where each subpacket of the set of multiple subpackets includes a subset of the data and an ID associated with the UE. The subpacket component 735 is capable of, configured to, or operable to support a means for transmitting the set of multiple subpackets via one or more resources of the self-scheduling resource pool.

In some examples, to support transmitting the set of multiple subpackets, the CRC component 740 is capable of, configured to, or operable to support a means for transmitting a set of multiple CRC corresponding to the set of multiple subpackets, where each subpacket includes a respective CRC.

In some examples, the subpacket component 735 is capable of, configured to, or operable to support a means for transmitting, via one or more subpackets of the set of multiple subpackets, a subpacket ID indicating one or more other subpackets of the set of multiple subpackets, an order associated with the set of multiple subpackets, a UE ID, or any combination thereof.

In some examples, the indication of the one or more other subpackets includes a signature that indicates a transmission of the set of multiple subpackets.

In some examples, the retransmission component 745 is capable of, configured to, or operable to support a means for receiving a DCI signal including a retransmission grant indicating a set of resources for retransmission of one or more subpackets of the set of multiple subpackets based on a reception status of the one or more subpackets of the set of multiple subpackets.

In some examples, the retransmission component 745 is capable of, configured to, or operable to support a means for retransmitting the one or more subpackets via the set of resources based on the retransmission grant.

In some examples, the feedback component 750 is capable of, configured to, or operable to support a means for receiving a set of feedback bits corresponding to the set of multiple subpackets, where each feedback bit corresponds to a reception status of a respective subpacket of the set of multiple subpackets.

In some examples, to support receiving the set of feedback bits, the feedback component 750 is capable of, configured to, or operable to support a means for receiving a DCI signal including the set of feedback bits.

In some examples, to support receiving the set of feedback bits, the feedback component 750 is capable of, configured to, or operable to support a means for receiving a MAC control element signal via a PDSCH including the set of feedback bits.

In some examples, the retransmission component 745 is capable of, configured to, or operable to support a means for retransmitting one or more subpackets of the set of multiple subpackets via a next instance of the self-scheduling resource pool, where the one or more subpackets correspond to one or more negative acknowledgment feedback bits of the set of feedback bits.

In some examples, the feedback component 750 is capable of, configured to, or operable to support a means for receiving an indication of a decoding status associated with the set of multiple subpackets, where receiving the set of feedback bits is based on the decoding status.

In some examples, the retransmission component 745 is capable of, configured to, or operable to support a means for receiving an indication of a transmit power control associated with a retransmissions of one or more subpackets of the set of multiple subpackets corresponding to one or more negative acknowledgment feedback bits of the set of feedback bits.

In some examples, the retransmission component 745 is capable of, configured to, or operable to support a means for retransmitting the one or more subpackets in accordance with the transmit power control.

In some examples, the feedback component 750 is capable of, configured to, or operable to support a means for receiving a set of feedback bits corresponding to a set of resources including at least the one or more resources, where each feedback bit corresponds to a reception of a subpacket via a respective resource.

In some examples, the feedback component 750 is capable of, configured to, or operable to support a means for detecting a reception status of the set of multiple subpackets based on mapping the one or more resources associated with transmission of the set of multiple subpackets to the set of resources.

In some examples, the retransmission component 745 is capable of, configured to, or operable to support a means for retransmitting one or more subpackets of the set of multiple subpackets based on the set of feedback bits, where the one or more subpackets are transmitted in accordance with a power ramp.

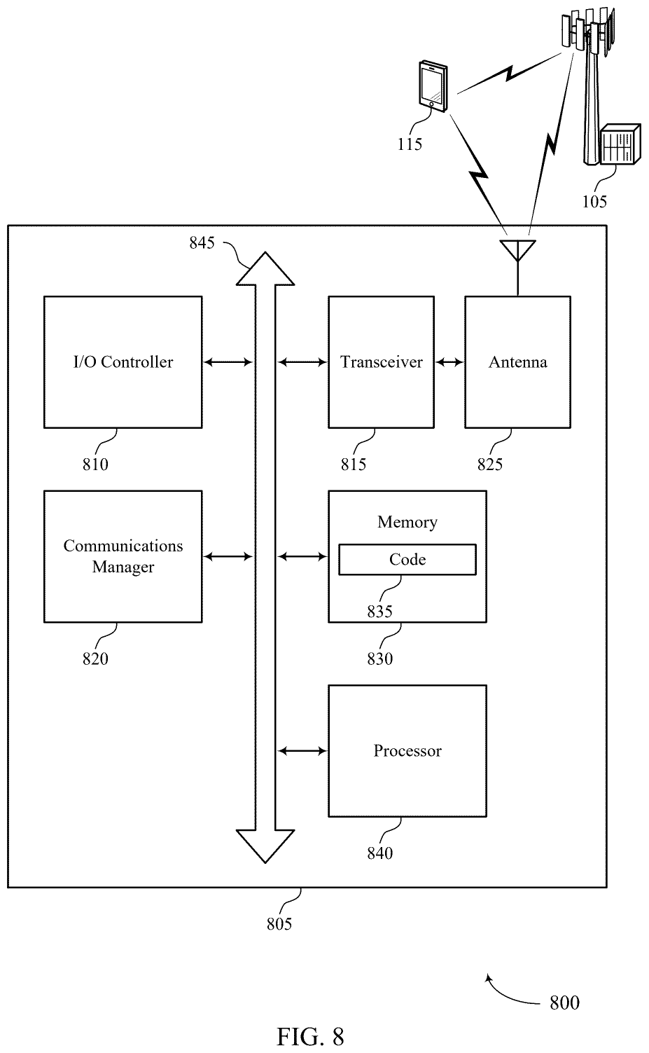

FIG. 8 shows a diagram of a system 800 including a device 805 that supports self-scheduling subpacket encoding in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting self-scheduling subpacket encoding). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving an indication of a self-scheduling resource pool associated with self-scheduling transmissions by the UE. The communications manager 820 is capable of, configured to, or operable to support a means for encoding, at a PHY layer, data associated with a packet into a set of multiple subpackets, where each subpacket of the set of multiple subpackets includes a subset of the data and an ID associated with the UE. The communications manager 820 is capable of, configured to, or operable to support a means for transmitting the set of multiple subpackets via one or more resources of the self-scheduling resource pool.

By including or configuring the communications manager 820 in accordance with examples as described herein, the device 805 may support techniques for improved communication reliability, reduced latency, reduced power consumption, more efficient utilization of communication resources, improved coordination between devices, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of self-scheduling subpacket encoding as described herein, or the at least one processor 840 and the at least one memory 830 may be otherwise configured to, individually or collectively, perform or support such operations.

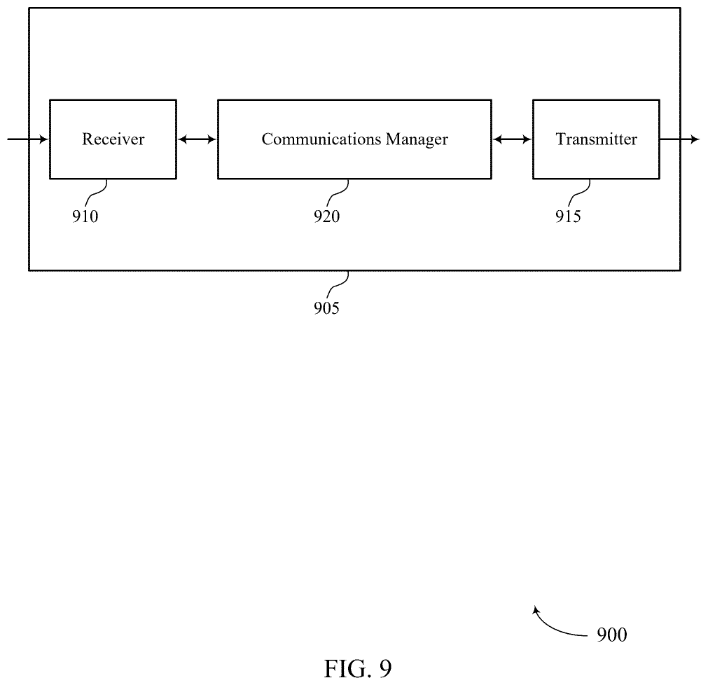

FIG. 9 shows a block diagram 900 of a device 905 that supports self-scheduling subpacket encoding in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques.

Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of self-scheduling subpacket encoding as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting an indication of a self-scheduling resource pool associated with self-scheduling transmissions by one or more UEs. The communications manager 920 is capable of, configured to, or operable to support a means for receiving one or more subpackets of a set of multiple subpackets via one or more resources of the self-scheduling resource pool. The communications manager 920 is capable of, configured to, or operable to support a means for decoding, at a PHY layer, data associated with a packet based on the one or more subpackets, where each subpacket of the one or more subpackets includes a subset of the data and an ID associated with a UE of the one or more UEs.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources, and the like.

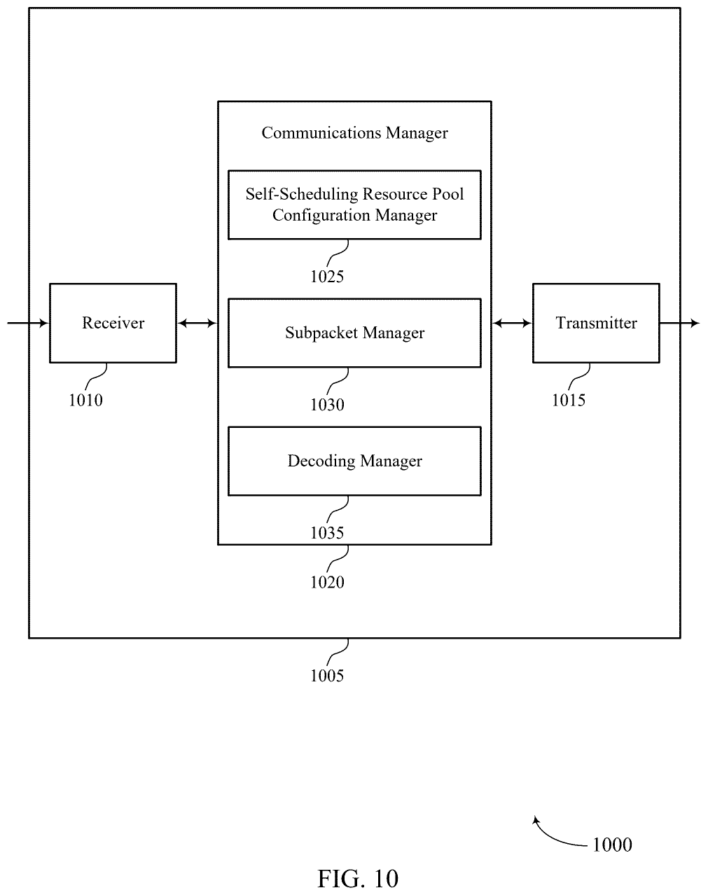

FIG. 10 shows a block diagram 1000 of a device 1005 that supports self-scheduling subpacket encoding in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of self-scheduling subpacket encoding as described herein. For example, the communications manager 1020 may include a self-scheduling resource pool configuration manager 1025, a subpacket manager 1030, a decoding manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The self-scheduling resource pool configuration manager 1025 is capable of, configured to, or operable to support a means for transmitting an indication of a self-scheduling resource pool associated with self-scheduling transmissions by one or more UEs. The subpacket manager 1030 is capable of, configured to, or operable to support a means for receiving one or more subpackets of a set of multiple subpackets via one or more resources of the self-scheduling resource pool. The decoding manager 1035 is capable of, configured to, or operable to support a means for decoding, at a PHY layer, data associated with a packet based on the one or more subpackets, where each subpacket of the one or more subpackets includes a subset of the data and an ID associated with a UE of the one or more UEs.

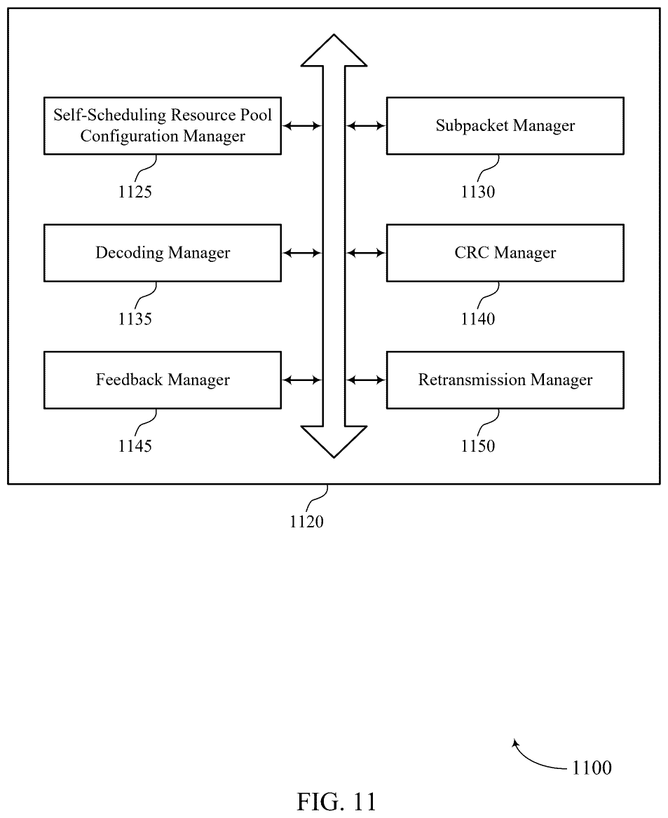

FIG. 11 shows a block diagram 1100 of a communications manager 1120 that supports self-scheduling subpacket encoding in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of self-scheduling subpacket encoding as described herein. For example, the communications manager 1120 may include a self-scheduling resource pool configuration manager 1125, a subpacket manager 1130, a decoding manager 1135, an CRC manager 1140, a feedback manager 1145, a retransmission manager 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The self-scheduling resource pool configuration manager 1125 is capable of, configured to, or operable to support a means for transmitting an indication of a self-scheduling resource pool associated with self-scheduling transmissions by one or more UEs. The subpacket manager 1130 is capable of, configured to, or operable to support a means for receiving one or more subpackets of a set of multiple subpackets via one or more resources of the self-scheduling resource pool. The decoding manager 1135 is capable of, configured to, or operable to support a means for decoding, at a PHY layer, data associated with a packet based on the one or more subpackets, where each subpacket of the one or more subpackets includes a subset of the data and an ID associated with a UE of the one or more UEs.

In some examples, to support receiving the set of multiple subpackets, the CRC manager 1140 is capable of, configured to, or operable to support a means for receiving a set of multiple CRC corresponding to the set of multiple subpackets, where each subpacket includes a respective CRC.

In some examples, the subpacket manager 1130 is capable of, configured to, or operable to support a means for receiving, via the one or more subpackets of the set of multiple subpackets, a subpacket ID indicating one or more other subpackets of the set of multiple subpackets, an order associated with the set of multiple subpackets, a UE ID, or any combination thereof.

In some examples, the indication of the one or more other subpackets includes a signature that indicates a transmission of the set of multiple subpackets.

In some examples, the feedback manager 1145 is capable of, configured to, or operable to support a means for transmitting a set of feedback bits corresponding to the set of multiple subpackets, where each feedback bit corresponds to a reception status of a respective subpacket of the set of multiple subpackets.

In some examples, the decoding manager 1135 is capable of, configured to, or operable to support a means for decoding at least one of the one or more subpackets, where transmitting the set of feedback bits is based on the decoding.

In some examples, to support transmitting the set of feedback bits, the feedback manager 1145 is capable of, configured to, or operable to support a means for transmitting a DCI signal including the set of feedback bits.

In some examples, to support transmitting the set of feedback bits, the feedback manager 1145 is capable of, configured to, or operable to support a means for transmitting a MAC control element signal via a PDSCH channel including the set of feedback bits.

In some examples, the retransmission manager 1150 is capable of, configured to, or operable to support a means for receiving retransmissions of one or more additional subpackets of the set of multiple subpackets via a next instance of the self-scheduling resource pool, where the one or more additional subpackets correspond to one or more negative acknowledgment feedback bits of the set of feedback bits.

In some examples, the feedback manager 1145 is capable of, configured to, or operable to support a means for transmitting an indication of a decoding status associated with the set of multiple subpackets, where transmitting the set of feedback bits is based on the decoding status.

In some examples, the retransmission manager 1150 is capable of, configured to, or operable to support a means for transmitting an indication of a transmit power control associated with a retransmissions of one or more additional subpackets of the set of multiple subpackets corresponding to one or more negative acknowledgment feedback bits of the set of feedback bits.

In some examples, the retransmission manager 1150 is capable of, configured to, or operable to support a means for receiving the one or more additional subpackets in accordance with the transmit power control.

In some examples, the retransmission manager 1150 is capable of, configured to, or operable to support a means for transmitting a DCI signal including a retransmission grant indicating a set of resources for retransmission of one or more additional subpackets of the set of multiple subpackets based on a reception status of the one or more additional subpackets of the set of multiple subpackets.

In some examples, the feedback manager 1145 is capable of, configured to, or operable to support a means for transmitting a set of feedback bits corresponding to a set of resources including at least the one or more resources, where each feedback bit corresponds to a reception of a subpacket via a respective resource.

In some examples, the retransmission manager 1150 is capable of, configured to, or operable to support a means for receiving retransmission of one or more additional subpackets of the set of multiple subpackets based on the set of feedback bits, where the one or more subpackets are transmitted at the UE in accordance with a power ramp.

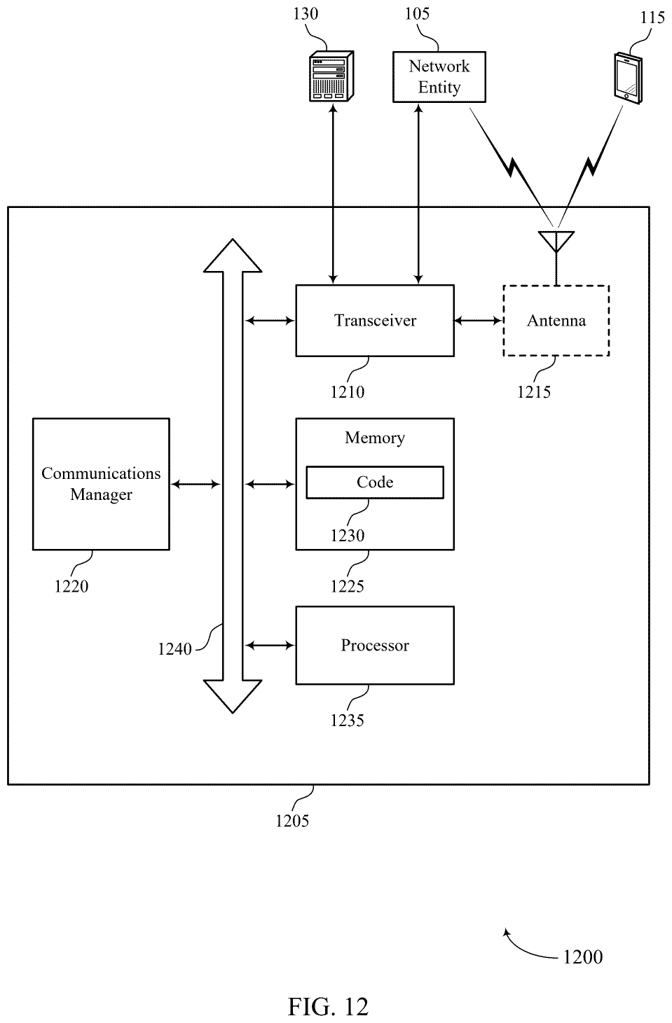

FIG. 12 shows a diagram of a system 1200 including a device 1205 that supports self-scheduling subpacket encoding in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting self-scheduling subpacket encoding). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting an indication of a self-scheduling resource pool associated with self-scheduling transmissions by one or more UEs. The communications manager 1220 is capable of, configured to, or operable to support a means for receiving one or more subpackets of a set of multiple subpackets via one or more resources of the self-scheduling resource pool. The communications manager 1220 is capable of, configured to, or operable to support a means for decoding, at a PHY layer, data associated with a packet based on the one or more subpackets, where each subpacket of the one or more subpackets includes a subset of the data and an ID associated with a UE of the one or more UEs.

By including or configuring the communications manager 1220 in accordance with examples as described herein, the device 1205 may support techniques for improved communication reliability, reduced latency, reduced power consumption, more efficient utilization of communication resources, improved coordination between devices, and the like.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of self-scheduling subpacket encoding as described herein, or the at least one processor 1235 and the at least one memory 1225 may be otherwise configured to, individually or collectively, perform or support such operations.

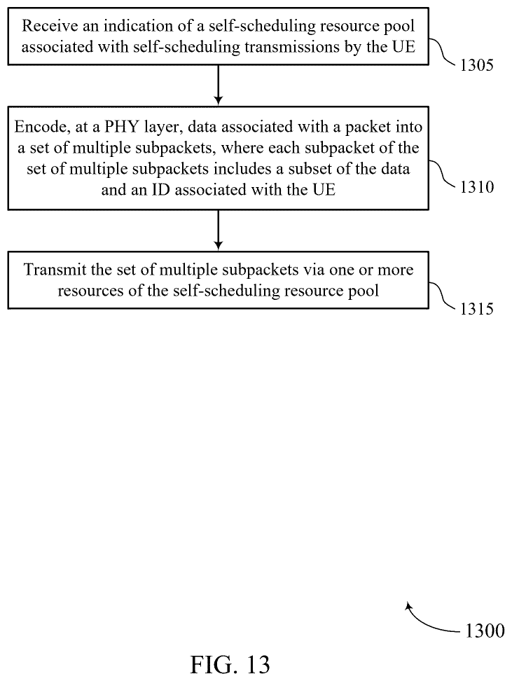

FIG. 13 shows a flowchart illustrating a method 1300 that supports self-scheduling subpacket encoding in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a self-scheduling resource pool associated with self-scheduling transmissions by the UE. The operations of 1305 may be performed in accordance with examples as disclosed herein. In some examples, aspects of the operations of 1305 may be performed by a self-scheduling resource pool configuration component 725 as described with reference to FIG. 7.

At 1310, the method may include encoding, at a PHY layer, data associated with a packet into a set of multiple subpackets, where each subpacket of the set of multiple subpackets includes a subset of the data and an ID associated with the UE. The operations of 1310 may be performed in accordance with examples as disclosed herein. In some examples, aspects of the operations of 1310 may be performed by an encoding component 730 as described with reference to FIG. 7.

At 1315, the method may include transmitting the set of multiple subpackets via one or more resources of the self-scheduling resource pool. The operations of 1315 may be performed in accordance with examples as disclosed herein. In some examples, aspects of the operations of 1315 may be performed by a subpacket component 735 as described with reference to FIG. 7.

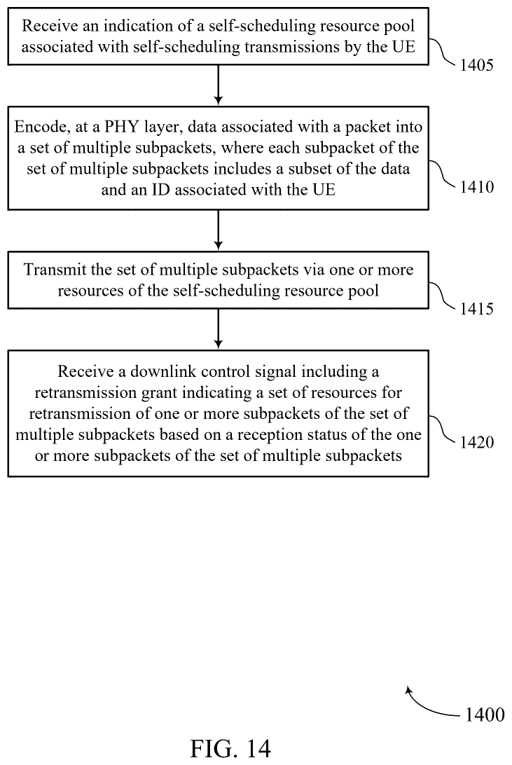

FIG. 14 shows a flowchart illustrating a method 1400 that supports self-scheduling subpacket encoding in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a self-scheduling resource pool associated with self-scheduling transmissions by the UE. The operations of 1405 may be performed in accordance with examples as disclosed herein. In some examples, aspects of the operations of 1405 may be performed by a self-scheduling resource pool configuration component 725 as described with reference to FIG. 7.

At 1410, the method may include encoding, at a PHY layer, data associated with a packet into a set of multiple subpackets, where each subpacket of the set of multiple subpackets includes a subset of the data and an ID associated with the UE. The operations of 1410 may be performed in accordance with examples as disclosed herein. In some examples, aspects of the operations of 1410 may be performed by an encoding component 730 as described with reference to FIG. 7.

At 1415, the method may include transmitting the set of multiple subpackets via one or more resources of the self-scheduling resource pool. The operations of 1415 may be performed in accordance with examples as disclosed herein. In some examples, aspects of the operations of 1415 may be performed by a subpacket component 735 as described with reference to FIG. 7.

At 1420, the method may include receiving a DCI signal including a retransmission grant indicating a set of resources for retransmission of one or more subpackets of the set of multiple subpackets based on a reception status of the one or more subpackets of the set of multiple subpackets. The operations of 1420 may be performed in accordance with examples as disclosed herein. In some examples, aspects of the operations of 1420 may be performed by a retransmission component 745 as described with reference to FIG. 7.

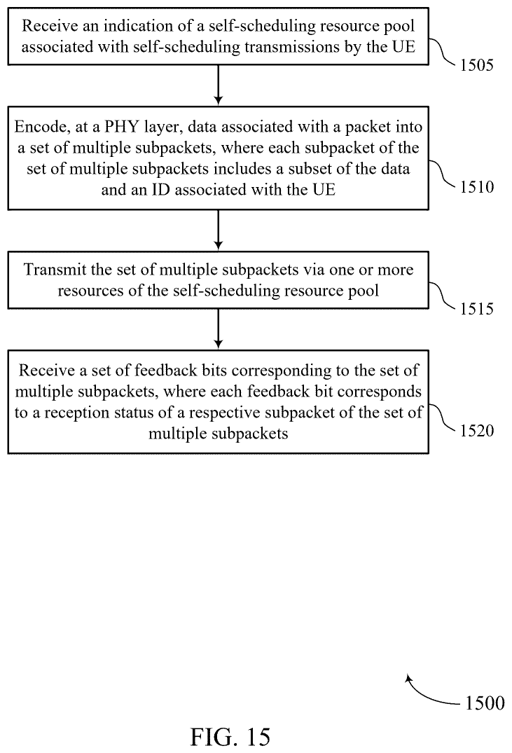

FIG. 15 shows a flowchart illustrating a method 1500 that supports self-scheduling subpacket encoding in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a self-scheduling resource pool associated with self-scheduling transmissions by the UE. The operations of 1505 may be performed in accordance with examples as disclosed herein. In some examples, aspects of the operations of 1505 may be performed by a self-scheduling resource pool configuration component 725 as described with reference to FIG. 7.

At 1510, the method may include encoding, at a PHY layer, data associated with a packet into a set of multiple subpackets, where each subpacket of the set of multiple subpackets includes a subset of the data and an ID associated with the UE. The operations of 1510 may be performed in accordance with examples as disclosed herein. In some examples, aspects of the operations of 1510 may be performed by an encoding component 730 as described with reference to FIG. 7.

At 1515, the method may include transmitting the set of multiple subpackets via one or more resources of the self-scheduling resource pool. The operations of 1515 may be performed in accordance with examples as disclosed herein. In some examples, aspects of the operations of 1515 may be performed by a subpacket component 735 as described with reference to FIG. 7.

At 1520, the method may include receiving a set of feedback bits corresponding to the set of multiple subpackets, where each feedback bit corresponds to a reception status of a respective subpacket of the set of multiple subpackets. The operations of 1520 may be performed in accordance with examples as disclosed herein. In some examples, aspects of the operations of 1520 may be performed by a feedback component 750 as described with reference to FIG. 7.

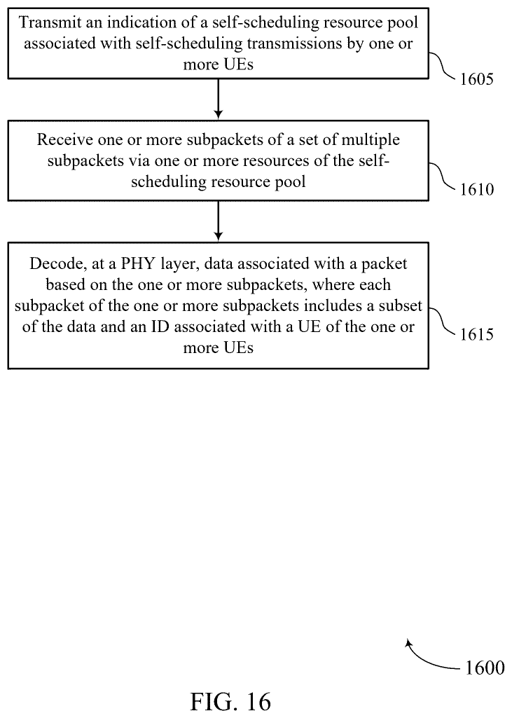

FIG. 16 shows a flowchart illustrating a method 1600 that supports self-scheduling subpacket encoding in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting an indication of a self-scheduling resource pool associated with self-scheduling transmissions by one or more UEs. The operations of 1605 may be performed in accordance with examples as disclosed herein. In some examples, aspects of the operations of 1605 may be performed by a self-scheduling resource pool configuration manager 1125 as described with reference to FIG. 11.

At 1610, the method may include receiving one or more subpackets of a set of multiple subpackets via one or more resources of the self-scheduling resource pool. The operations of 1610 may be performed in accordance with examples as disclosed herein. In some examples, aspects of the operations of 1610 may be performed by a subpacket manager 1130 as described with reference to FIG. 11.

At 1615, the method may include decoding, at a PHY layer, data associated with a packet based on the one or more subpackets, where each subpacket of the one or more subpackets includes a subset of the data and an ID associated with a UE of the one or more UEs. The operations of 1615 may be performed in accordance with examples as disclosed herein. In some examples, aspects of the operations of 1615 may be performed by a decoding manager 1135 as described with reference to FIG. 11.

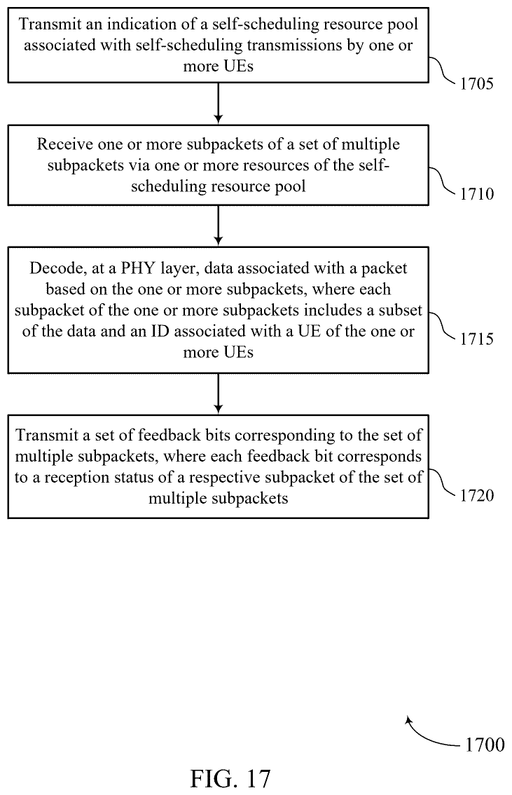

FIG. 17 shows a flowchart illustrating a method 1700 that supports self-scheduling subpacket encoding in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting an indication of a self-scheduling resource pool associated with self-scheduling transmissions by one or more UEs. The operations of 1705 may be performed in accordance with examples as disclosed herein. In some examples, aspects of the operations of 1705 may be performed by a self-scheduling resource pool configuration manager 1125 as described with reference to FIG. 11.

At 1710, the method may include receiving one or more subpackets of a set of multiple subpackets via one or more resources of the self-scheduling resource pool. The operations of 1710 may be performed in accordance with examples as disclosed herein. In some examples, aspects of the operations of 1710 may be performed by a subpacket manager 1130 as described with reference to FIG. 11.

At 1715, the method may include decoding, at a PHY layer, data associated with a packet based on the one or more subpackets, where each subpacket of the one or more subpackets includes a subset of the data and an ID associated with a UE of the one or more UEs. The operations of 1715 may be performed in accordance with examples as disclosed herein. In some examples, aspects of the operations of 1715 may be performed by a decoding manager 1135 as described with reference to FIG. 11.

At 1720, the method may include transmitting a set of feedback bits corresponding to the set of multiple subpackets, where each feedback bit corresponds to a reception status of a respective subpacket of the set of multiple subpackets. The operations of 1720 may be performed in accordance with examples as disclosed herein. In some examples, aspects of the operations of 1720 may be performed by a feedback manager 1145 as described with reference to FIG. 11.

The following provides an overview of aspects of the present disclosure:
Aspect 1: A method by a UE, comprising: receiving an indication of a self-scheduling resource pool associated with self-scheduling transmissions by the UE; encoding, at a PHY layer, data associated with a packet into a plurality of subpackets, wherein each subpacket of the plurality of subpackets comprises a subset of the data and an ID associated with the UE; and transmitting the plurality of subpackets via one or more resources of the self-scheduling resource pool.
Aspect 2: The method of aspect 1, wherein to transmitting the plurality of subpackets further comprises: transmitting a plurality of CRC corresponding to the plurality of subpackets, wherein each subpacket comprises a respective CRC.
Aspect 3: The method of any of aspects 1 through 2, further comprising: transmitting, via one or more subpackets of the plurality of subpackets, one or more of: a subpacket ID indicating one or more other subpackets of the plurality of subpackets, an order associated with the plurality of subpackets, the ID associated with the UE, or any combination thereof.
Aspect 4: The method of aspect 3, wherein the indication of the one or more other subpackets comprises a signature that indicates a transmission of the plurality of subpackets.
Aspect 5: The method of any of aspects 1 through 4, further comprising: receiving a downlink control signal comprising a retransmission grant indicating a set of resources for retransmission of one or more subpackets of the plurality of subpackets based at least in part on a reception status of the one or more subpackets of the plurality of subpackets.
Aspect 6: The method of aspect 5, further comprising: retransmitting the one or more subpackets via the set of resources based at least in part on the retransmission grant.
Aspect 7: The method of any of aspects 1 through 3, further comprising: receiving a set of feedback bits corresponding to the plurality of subpackets, wherein each feedback bit corresponds to a reception status of a respective subpacket of the plurality of subpackets.
Aspect 8: The method of aspect 7, wherein to receiving the set of feedback bits further comprises: receiving a downlink control signal comprising the set of feedback bits.
Aspect 9: The method of aspect 7, wherein to receiving the set of feedback bits further comprises: receiving a MAC-CE signal via a PDSCH comprising the set of feedback bits.
Aspect 10: The method of any of aspects 7 through 9, further comprising: retransmitting one or more subpackets of the plurality of subpackets via a next instance of the self-scheduling resource pool, wherein the one or more subpackets correspond to one or more NACK feedback bits of the set of feedback bits.
Aspect 11: The method of any of aspects 7 through 10, further comprising: receiving an indication of a decoding status associated with the plurality of subpackets, wherein receiving the set of feedback bits is based at least in part on the decoding status.
Aspect 12: The method of any of aspects 7 through 11, further comprising: receiving an indication of a transmit power control associated with a retransmissions of one or more subpackets of the plurality of subpackets corresponding to one or more NACK feedback bits of the set of feedback bits.
Aspect 13: The method of aspect 12, further comprising: retransmitting the one or more subpackets in accordance with the transmit power control.
Aspect 14: The method of any of aspects 1 through 3, further comprising: receiving a set of feedback bits corresponding to a set of resources comprising at least the one or more resources, wherein each feedback bit corresponds to a reception of a subpacket via a respective resource.
Aspect 15: The method of aspect 14, further comprising: detecting a reception status of the plurality of subpackets based at least in part on mapping the one or more resources associated with transmission of the plurality of subpackets to the set of resources.
Aspect 16: The method of any of aspects 14 through 15, further comprising: retransmitting one or more subpackets of the plurality of subpackets based at least in part on the set of feedback bits, wherein the one or more subpackets are transmitted in accordance with a power ramp.
Aspect 17: A method by a network entity, comprising: transmitting an indication of a self-scheduling resource pool associated with self-scheduling transmissions by one or more UEs; receiving one or more subpackets of a plurality of subpackets via one or more resources of the self-scheduling resource pool; and decode, at a PHY layer, data associating with a packet based at least in part on the one or more subpackets, wherein each subpacket of the one or more subpackets comprises a subset of the data and an ID associated with a UE of the one or more UEs.
Aspect 18: The method of aspect 17, wherein to receiving the plurality of subpackets further comprises: receiving a plurality of CRC corresponding to the plurality of subpackets, wherein each subpacket comprises a respective CRC.
Aspect 19: The method of any of aspects 17 through 18, further comprising: receiving, via the one or more subpackets of the plurality of subpackets, a subpacket ID indicating one or more other subpackets of the plurality of subpackets, an order associated with the plurality of subpackets, the ID associated with the UE, or any combination thereof.
Aspect 20: The method of aspect 19, wherein the indication of the one or more other subpackets comprises a signature that indicates a transmission of the plurality of subpackets.
Aspect 21: The method of any of aspects 17 through 20, further comprising: transmitting a set of feedback bits corresponding to the plurality of subpackets, wherein each feedback bit corresponds to a reception status of a respective subpacket of the plurality of subpackets.
Aspect 22: The method of aspect 21, further comprising: decode at least one of the one or more subpackets, wherein transmitting the set of feedback bits is based at least in part on the decoding.
Aspect 23: The method of any of aspects 21 through 22, wherein to transmitting the set of feedback bits further comprises: transmitting a downlink control signal comprising the set of feedback bits.
Aspect 24: The method of any of aspects 21 through 22, wherein to transmitting the set of feedback bits further comprises: transmitting a MAC-CE signal via a PDSCH comprising the set of feedback bits.
Aspect 25: The method of any of aspects 21 through 24, further comprising: receiving retransmissions of one or more additional subpackets of the plurality of subpackets via a next instance of the self-scheduling resource pool, wherein the one or more additional subpackets correspond to one or more NACK feedback bits of the set of feedback bits.
Aspect 26: The method of any of aspects 21 through 25, further comprising: transmitting an indication of a decoding status associated with the plurality of subpackets, wherein transmitting the set of feedback bits is based at least in part on the decoding status.
Aspect 27: The method of any of aspects 17 through 20, further comprising: transmitting a downlink control signal comprising a retransmission grant indicating a set of resources for retransmission of one or more additional subpackets of the plurality of subpackets based at least in part on a reception status of the one or more additional subpackets of the plurality of subpackets.
Aspect 28: The method of any of aspects 17 through 20, further comprising: transmitting a set of feedback bits corresponding to a set of resources comprising at least the one or more resources, wherein each feedback bit corresponds to a reception of a subpacket via a respective resource.
Aspect 29: A UE comprising one or more memories storing processor-executable code, and one or more processors coupled with the one or more memories and individually or collectively operable to execute the code to cause the UE to perform a method of any of aspects 1 through 16.
Aspect 30: A UE comprising at least one means for performing a method of any of aspects 1 through 16.
Aspect 31: A non-transitory computer-readable medium storing code the code comprising instructions executable by one or more processors to perform a method of any of aspects 1 through 16.
Aspect 32: A network entity comprising one or more memories storing processor-executable code, and one or more processors coupled with the one or more memories and individually or collectively operable to execute the code to cause the network entity to perform a method of any of aspects 17 through 28.
Aspect 33: A network entity comprising at least one means for performing a method of any of aspects 17 through 28.
Aspect 34: A non-transitory computer-readable medium storing code the code comprising instructions executable by one or more processors to perform a method of any of aspects 17 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a self-scheduling resource pool associated with self-scheduling transmissions by the UE;
encode, at a physical layer, data associated with a packet into a plurality of subpackets, wherein each subpacket of the plurality of subpackets comprises a subset of the data and an identifier associated with the UE; and
transmit the plurality of subpackets via one or more resources of the self-scheduling resource pool.

2. The UE of claim 1, wherein, to transmit the plurality of subpackets, the one or more processors are individually or collectively further operable to execute the code to cause the UE to:
transmit a plurality of cyclic redundancy check corresponding to the plurality of subpackets, wherein each subpacket comprises a respective cyclic redundancy check.

3. The UE of claim 1, wherein the one or more processors are individually or collectively further operable to execute the code to cause the UE to:
transmit, via one or more subpackets of the plurality of subpackets, one or more of: a subpacket identifier indicating one or more other subpackets of the plurality of subpackets, an order associated with the plurality of subpackets, the identifier associated with the UE, or any combination thereof.

4. The UE of claim 3, wherein the indication of the one or more other subpackets comprises a signature that indicates a transmission of the plurality of subpackets.

5. The UE of claim 1, wherein the one or more processors are individually or collectively further operable to execute the code to cause the UE to:
receive a downlink control signal comprising a retransmission grant indicating a set of resources for retransmission of one or more subpackets of the plurality of subpackets based at least in part on a reception status of the one or more subpackets of the plurality of subpackets.

6. The UE of claim 5, wherein the one or more processors are individually or collectively further operable to execute the code to cause the UE to:
retransmit the one or more subpackets via the set of resources based at least in part on the retransmission grant.

7. The UE of claim 1, wherein the one or more processors are individually or collectively further operable to execute the code to cause the UE to:
receive a set of feedback bits corresponding to the plurality of subpackets, wherein each feedback bit corresponds to a reception status of a respective subpacket of the plurality of subpackets.

8. The UE of claim 7, wherein, to receive the set of feedback bits, the one or more processors are individually or collectively further operable to execute the code to cause the UE to:
receive a downlink control signal comprising the set of feedback bits.

9. The UE of claim 7, wherein, to receive the set of feedback bits, the one or more processors are individually or collectively further operable to execute the code to cause the UE to:
receive a medium access control (MAC) control element (MAC CE) signal via a physical downlink shared channel comprising the set of feedback bits.

10. The UE of claim 7, wherein the one or more processors are individually or collectively further operable to execute the code to cause the UE to:
retransmit one or more subpackets of the plurality of subpackets via a next instance of the self-scheduling resource pool, wherein the one or more subpackets correspond to one or more negative acknowledgment feedback bits of the set of feedback bits.

11. The UE of claim 7, wherein the one or more processors are individually or collectively further operable to execute the code to cause the UE to:
receive an indication of a decoding status associated with the plurality of subpackets, wherein receiving the set of feedback bits is based at least in part on the decoding status.

12. The UE of claim 7, wherein the one or more processors are individually or collectively further operable to execute the code to cause the UE to:
receive an indication of a transmit power control associated with a retransmissions of one or more subpackets of the plurality of subpackets corresponding to one or more negative acknowledgment feedback bits of the set of feedback bits.

13. The UE of claim 12, wherein the one or more processors are individually or collectively further operable to execute the code to cause the UE to:
retransmit the one or more subpackets in accordance with the transmit power control.

14. The UE of claim 1, wherein the one or more processors are individually or collectively further operable to execute the code to cause the UE to:
receive a set of feedback bits corresponding to a set of resources comprising at least the one or more resources, wherein each feedback bit corresponds to a reception of a subpacket via a respective resource.

15. The UE of claim 14, wherein the one or more processors are individually or collectively further operable to execute the code to cause the UE to:
detect a reception status of the plurality of subpackets based at least in part on mapping the one or more resources associated with transmission of the plurality of subpackets to the set of resources.

16. The UE of claim 14, wherein the one or more processors are individually or collectively further operable to execute the code to cause the UE to:
retransmit one or more subpackets of the plurality of subpackets based at least in part on the set of feedback bits, wherein the one or more subpackets are transmitted in accordance with a power ramp.

17. A network entity, comprising:
one or more memories storing processor-executable code; and
one or more processors coupled with the one or more memories and individually or collectively operable to execute the code to cause the network entity to:
transmit an indication of a self-scheduling resource pool associated with self-scheduling transmissions by one or more user equipments (UEs);
receive one or more subpackets of a plurality of subpackets via one or more resources of the self-scheduling resource pool; and
decode, at a physical layer, data associated with a packet based at least in part on the one or more subpackets, wherein each subpacket of the one or more subpackets comprises a subset of the data and an identifier associated with a UE of the one or more UEs.

18. The network entity of claim 17, wherein, to receive the plurality of subpackets, the one or more processors are individually or collectively further operable to execute the code to cause the network entity to:
receive a plurality of cyclic redundancy check corresponding to the plurality of subpackets, wherein each subpacket comprises a respective cyclic redundancy check.

19. The network entity of claim 17, wherein the one or more processors are individually or collectively further operable to execute the code to cause the network entity to:
receive, via the one or more subpackets of the plurality of subpackets, a subpacket identifier indicating one or more other subpackets of the plurality of subpackets, an order associated with the plurality of subpackets, the identifier associated with the UE, or any combination thereof.

20. The network entity of claim 19, wherein the indication of the one or more other subpackets comprises a signature that indicates a transmission of the plurality of subpackets.

21. The network entity of claim 17, wherein the one or more processors are individually or collectively further operable to execute the code to cause the network entity to:
transmit a set of feedback bits corresponding to the plurality of subpackets, wherein each feedback bit corresponds to a reception status of a respective subpacket of the plurality of subpackets.

22. The network entity of claim 21, wherein the one or more processors are individually or collectively further operable to execute the code to cause the network entity to:
decode at least one of the one or more subpackets, wherein transmitting the set of feedback bits is based at least in part on the decoding.

23. The network entity of claim 21, wherein, to transmit the set of feedback bits, the one or more processors are individually or collectively further operable to execute the code to cause the network entity to:
transmit a downlink control signal comprising the set of feedback bits.

24. The network entity of claim 21, wherein, to transmit the set of feedback bits, the one or more processors are individually or collectively further operable to execute the code to cause the network entity to:
transmit a medium access control (MAC) control element (MAC CE) signal via a physical downlink shared channel comprising the set of feedback bits.

25. The network entity of claim 21, wherein the one or more processors are individually or collectively further operable to execute the code to cause the network entity to:
receive retransmissions of one or more additional subpackets of the plurality of subpackets via a next instance of the self-scheduling resource pool, wherein the one or more additional subpackets correspond to one or more negative acknowledgment feedback bits of the set of feedback bits.

26. The network entity of claim 21, wherein the one or more processors are individually or collectively further operable to execute the code to cause the network entity to:
transmit an indication of a decoding status associated with the plurality of subpackets, wherein transmitting the set of feedback bits is based at least in part on the decoding status.

27. The network entity of claim 17, wherein the one or more processors are individually or collectively further operable to execute the code to cause the network entity to:
transmit a downlink control signal comprising a retransmission grant indicating a set of resources for retransmission of one or more additional subpackets of the plurality of subpackets based at least in part on a reception status of the one or more additional subpackets of the plurality of subpackets.

28. The network entity of claim 17, wherein the one or more processors are individually or collectively further operable to execute the code to cause the network entity to:
transmit a set of feedback bits corresponding to a set of resources comprising at least the one or more resources, wherein each feedback bit corresponds to a reception of a subpacket via a respective resource.

29. A method for wireless communications at a user equipment (UE), comprising:
receiving an indication of a self-scheduling resource pool associated with self-scheduling transmissions by the UE;
encoding, at a physical layer, data associated with a packet into a plurality of subpackets, wherein each subpacket of the plurality of subpackets comprises a subset of the data and an identifier associated with the UE; and
transmitting the plurality of subpackets via one or more resources of the self-scheduling resource pool.

30. A method for wireless communications at a network entity, comprising:
transmitting an indication of a self-scheduling resource pool associated with self-scheduling transmissions by one or more user equipments (UEs);
receiving one or more subpackets of a plurality of subpackets via one or more resources of the self-scheduling resource pool; and
decoding, at a physical layer, data associated with a packet based at least in part on the one or more subpackets, wherein each subpacket of the one or more subpackets comprises a subset of the data and an identifier associated with a UE of the one or more UEs.
